(19) United States
(12) Patent Application Publication
(10) Pub. No.: US 2006/0168738 A1
(43) Pub. Date: Aug. 3, 2006

(54) Product and process for consumer application of stain and water repellent to fabrics

(76) Inventor: Walter K. Lim, Rancho Santa Fe, CA (US)

Correspondence Address: Dennis H. Lambert, 7000 View Park Drive, Burke, VA, 22015, US

(21) Appl. No.: 11/332,743

(22) Filed: Jan. 13, 2006

Related U.S. Application Data
(63) Continuation-in-part of application No. 10/183,277, filed on Jun. 27, 2002, now abandoned.

(51) Int. Cl. C11D 3/00

(52) U.S. Cl. 8/115.51

(57) ABSTRACT

A product and process for imparting stain and water repellency to fabric, wherein a heat-curable resin which has the property of imparting stain and water repellency to fabric when applied in proper amount to the fabric and cured, and that can be dispensed as an aerosol, is mixed in suitable proportion with a diluent and placed in an aerosol container along with a suitable propellant. The composition is then sprayed onto the fabric until the fabric is wet. The concentration of the resin in the composition is such that when the fabric is wet with the composition, an appropriate amount of the resin is on the fabric to impart stain and water repellency to it when the fabric is dried and the resin cured. Curing of the resin can be accomplished by ironing the fabric, or by drying the fabric in a clothes dryer at normal settings. A gaseous propellant is used to pressurize and discharge the composition, and a reserve supply of gaseous propellant is stored on a gas adsorbent material placed in the container.

This application is a continuation-in-part of application Ser. No. 10/183,277, filed Jun. 27, 2002.

### BACKGROUND OF THE INVENTION

1. Field of the Invention

The invention relates generally to products and processes for the treatment of fabrics to render them stain and water repellent. In particular, the invention relates to a product and process for consumer application of a stain and water repellent composition to fabric.

2. Prior Art

Fabrics are often treated to impart stain and water repellency to them. These treatments are frequently conducted on a commercial scale, wherein a suitable water proofing and stain resistant composition is applied to large sheets or rolls of the fabric to be treated. The composition is typically applied by spraying, padding, roller coating or knife coating. In some processes, the fabric is passed through a bath containing the composition, and then passed through a drying oven to dry the fabric.

The commercial products used for making fabrics stain and water repellent include the systems sold by Fiber-Shield Industries of Yaphank, N.Y., under the names FS-7550 and FS-7520. The FS-7550 product is a concentrated fluoropolymer water system, and is slightly cationic. It is sold as a liquid in five, thirty and fifty-five gallon containers, and can be applied via spraying, padding, roller coating or knife coating. In use, 4-6 parts, by weight, of FS-7550 are diluted with 96-94 parts of water and mixed for at least three minutes. Isopropyl alcohol can be added as a preservative. When sprayed onto fabric, the composition normally dries in 10 minutes to 1 hour, depending upon ambient conditions and the amount of composition applied to the fabric. When allowed to air dry, full cure can take about 72 hours. Alternatively, 2-3% of FS-7550 can be added to the rinse cycle of a washing machine to add the composition to the fabric. The fabric is then dried in a dryer at 160° F., and/or ironed. However, the slightly cationic property of the composition may cause it to attach to the surface of machinery, resulting in gumming up of the machinery.

The FS-7520 product is an air-cured, mildly cationic concentrated fluoropolymer water system, and is sold as a liquid in five, thirty and fifty-five gallon containers. This product is intended to be applied via spraying, padding or roller coating. In use, 7-10 parts, by weight, of FS-7520 are diluted with 93-90 parts of water and mixed for at least three minutes. Isopropyl alcohol can be added as a preservative. When applied to fabric or carpeting, the composition will be dry to the touch within 10 minutes to 1 hour, depending upon the amount of product sprayed and the ambient conditions. Full cure takes place in approximately 24-48 hours.

Both the FS-7550 and FS-7520 products are intended for use in the commercial treatment of fabric to impart stain and water repellency, and are formulated and packaged accordingly.

Other products have been developed for consumer application to fabric to impart stain and water repellency to the fabric. These consumer products have limited effectiveness, and some have been withdrawn from the market because of their carcinogenic properties.

In applicant's prior copending application Ser. No. 10/183,277, a system is disclosed for consumer application of an environmentally safe stain and water repellent to fabric, wherein a resin is applied from an aerosol container. However, there is a tendency for the resin to precipitate out and thus not be available in appropriate concentration in the solution when sprayed from the container. It is believed that this is due to the presence of liquid propellant in the container.

Thus, there is need for a safe and effective consumer product that can be applied via aerosol or pressurized container to impart stain and water repellency to fabrics, and wherein the active ingredient does not precipitate out of solution so as to render the spray ineffective.

### SUMMARY OF THE INVENTION

The invention comprises a superior, heat-curable, non-toxic, resin-based aqueous composition that is packaged in an aerosol or pressurized container for consumer application to fabric to impart stain and water repellency to the fabric, wherein the active resin ingredient does not precipitate out and thus is available for spraying onto the fabric.

The FS-7520 composition of Fiber-Shield Industries, when suitably modified, makes a composition suitable for consumer application via aerosol or pressurized container. The FS-7520 composition comprises 14-16% solids, and applicant dilutes this with water to 3-4% solids. A suitable commercially available corrosion inhibitor may also be added. The diluted composition is then packaged in an aerosol or pressurized container for consumer use as described above.

The concentration of the effective resin-based component in the composition is such that the consumer simply sprays the composition onto the fabric until the fabric is wet, whereupon the appropriate amount of the effective component will have been applied to the fabric to impart stain and water repellency to the fabric. The wetted fabric is then ironed or placed in a typical clothes dryer and dried at a normal setting. The heat generated by ironing and/or drying the fabric in a clothes dryer sets or cures the resin-based component, imparting a stain and water repellent property to the fabric that is superior to the results obtained with prior art consumer products and processes.

Precipitation of the active resin ingredient out of solution is avoided in the present invention by storing a quantity of gaseous propellant on a body of material placed in the container along with the product. As pressure is depleted from the container, additional gaseous propellant is released from the storage material and into the container to maintain a desired pressure on the product. Since it is not necessary to place liquid propellant in the container, the active resin ingredient remains in solution and is available for discharge with the spray. Gas storage materials, gasses, and processes as disclosed in applicant's copending application Ser. No. 11/250,235, filed Oct. 14, 2005, may be used in the system of the present invention, and the entire disclosure of that application is incorporated herein by reference.

### BRIEF DESCRIPTION OF THE DRAWINGS

The foregoing and other objects and advantages of the invention will become apparent from the following detailed description when considered in conjunction with the accompanying drawings, wherein like reference characters designate like parts throughout the several views, and wherein:

FIG. 1 is a longitudinal sectional view of an aerosol container for consumer application of the stain and water repellent composition of the invention.

FIG. 2 is a schematic block diagram of one process for treating fabric in accordance with the invention to impart stain and water repellency to the fabric.

FIG. 3 is a schematic block diagram of another process for treating fabric in accordance with the invention to impart stain and water repellency to the fabric.

FIG. 4 is a longitudinal sectional view of an aerosol container for consumer application of the stain and water repellent composition of the invention, wherein a mass of gas storage material is in the container with the product for releasing gaseous propellant into the container to maintain a desired pressure.

### DETAILED DESCRIPTION OF THE PREFERRED EMBODIMENTS

In accordance with the invention, a heat-curable resin which has the property of imparting stain and water repellency to fabric when applied in proper amount to the fabric and cured, and that can be dispensed as an aerosol, is mixed in suitable proportion with a diluent and placed in an aerosol container along with a mass of material storing a quantity of pressurized gaseous propellant. The composition is sprayed onto the fabric until the fabric is wet. The concentration of the resin in the composition is such that when the fabric is wet with the composition, an appropriate amount of the resin is on the fabric to impart stain and water repellency to it when the fabric is dried and the resin cured. Curing of the resin can be accomplished by ironing the fabric, or by drying the fabric in a clothes dryer at normal settings.

A particular resin which has been found suitable for use in the composition of the invention is FS-7520, manufactured by Fiber-Shield Industries, Inc. of Yaphank, N.Y. FS-7520 is an aqueous-based concentrated fluoropolymer system that cures at ambient temperatures. For use in the invention, this product is diluted with water to 3%-4% solids, and, if desired, a suitable commercially available corrosion inhibitor added. The composition is then packaged in a conventional aerosol or pressurized container for use by a consumer to impart stain and water repellency to fabrics. The consumer simply sprays the composition onto the fabric until the fabric is wet, and the concentration of resin in the composition is such that when the fabric is wet an appropriate amount of the resin will be present on the fabric to impart stain and water repellency to it when the fabric is dried and the resin cured by application of heat. Curing of the resin can be accomplished by ironing the fabric, or by drying it in a clothes dryer at normal settings.

Precipitation of the resin out of solution is avoided in the present invention by the use of gaseous propellant instead of liquid propellant. Liquid propellant normally would be required in order to maintain adequate pressure in the container as product is depleted, but applicant is able to use gaseous propellant in the present invention because of the use of a mass of gas storage material in the container, on which a quantity of pressurized gaseous propellant is adsorbed. As pressure in the container decreases due to depletion of the product, additional gaseous propellant under pressure is released from the storage material to maintain a desired pressure in the container.

Treatment of fabric in accordance with the invention produces results superior to those obtained by prior art products and processes, and is easily achieved.

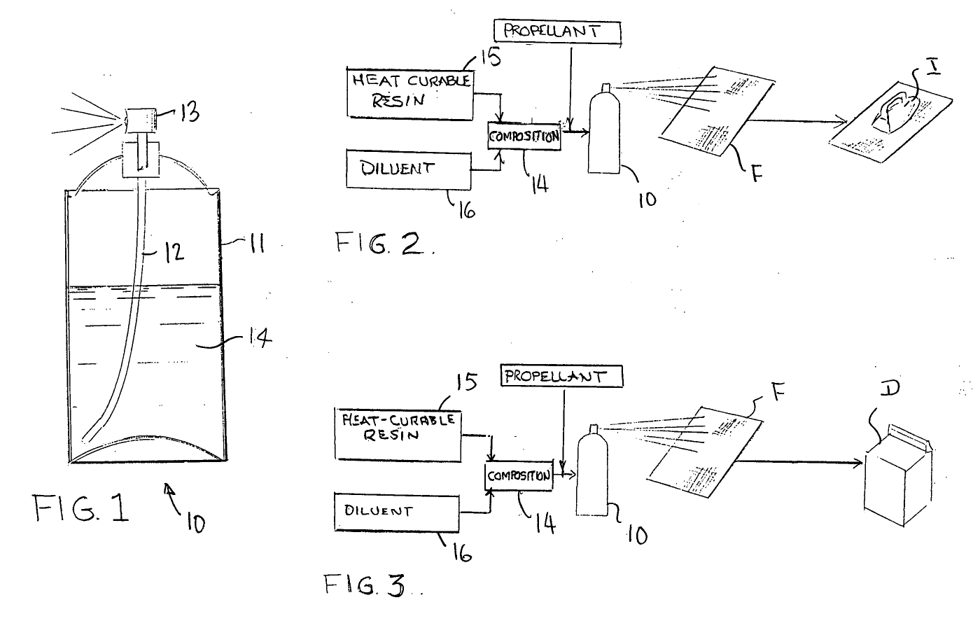

FIG. 1 depicts a typical conventional aerosol dispenser 10 which can be used in practicing the invention. The dispenser includes a container 11 with a dip tube 12 and actuator-nozzle 13. A desired quantity of the composition 14 of the invention is placed in the aerosol dispenser by using conventional methods, and a suitable propellant is added to pressurize the contents of the package in order that the resin composition can be sprayed. Further, it is recognized that the product could be sprayed with a finger pump or a trigger sprayer, but this would be tiring for covering large objects. For instance, a raincoat would require eight to ten fluid ounces for coverage.

FIG. 2 schematically depicts one process for practicing the invention, wherein a heat-curable resin 15 that can be dispensed as an aerosol is diluted with a suitable diluent 16 to obtain a composition 14 having 3% to 4% solids. In a preferred embodiment, the resin preferably comprises FS-7520 manufactured by Fiber-Shield Industries, Inc. of Yaphank, N.Y., and is diluted with water. The composition is packaged according to conventional methods in a conventional aerosol dispenser 10, from which the composition is sprayed onto fabric F until the fabric is wet. The concentration of resin in the composition is such that when the fabric is wet, an appropriate amount of the resin will be present on the fabric to impart stain and water repellency to it when the fabric is dried and the resin cured. Curing of the resin can be accomplished by ironing the fabric with an iron I.

FIG. 3 schematically depicts another process for practicing the invention, wherein all the steps shown in FIG. 2 are followed, except that the resin is cured by placing the wetted fabric F in a clothes dryer D to dry the fabric and cure the resin. The fabric may also be ironed and otherwise handled conventionally upon removal from the dryer.

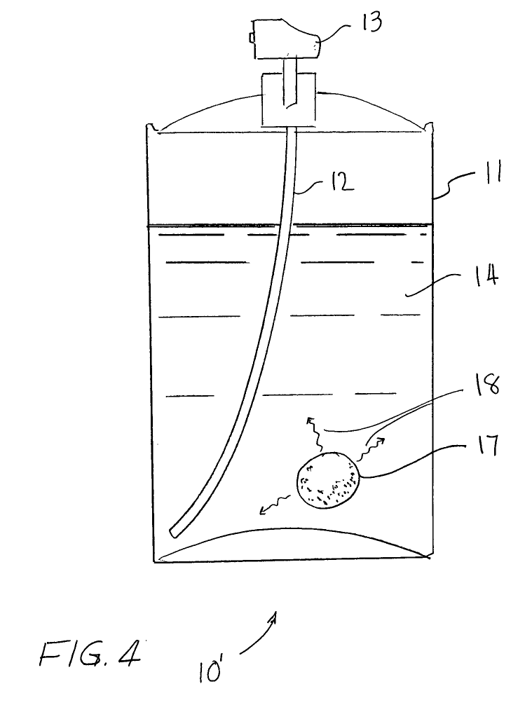

FIG. 4 depicts an embodiment wherein a mass of gas storage material 17 is placed in the container for storing under pressure a quantity of gaseous propellant 18. As product is depleted, additional gaseous propellant under pressure is released from the storage material to maintain a desired pressure in the container. This avoids the need for a liquid propellant and the concomitant precipitation of resin from solution. The storage material may comprise activated carbon or other material capable of storing and then releasing sufficiently large quantities of gaseous propellant. The propellant may comprise, for example, CO₂, or other suitable gasses, including those disclosed in applicant's earlier application Ser. No. 11/250,235.

Although stain and water repellency can be imparted to fabric by applying the composition of the invention and permitting it to air-dry under ambient conditions, cross linking or polymerization of the resin is achieved more effectively by subjecting the material to heat, e.g., by ironing the treated fabric or drying it in a clothes dryer after the composition has been applied to the fabric.

While particular embodiments of the invention have been illustrated and described herein, it should be understood that various changes and modifications may be made to the invention without departing from the spirit and intent of the invention as defined by the claims appended hereto.

What is claimed is:

1. An aerosol product for consumer application of a treatment to a previously untreated fabric to impart stain and water repellency to the fabric, comprising:
an aerosol container holding a quantity of a composition comprising an aqueous-based fluoropolymer resin and water, wherein the concentration of resin solids in the composition is 3% to 4% of the composition, said resin having the property of imparting stain and water repellency to fabric when sprayed onto a dry fabric until the fabric is wet and the resin is then cured, said composition having a consistency to enable it to be sprayed in a uniform fine mist from an aerosol container, and said concentration of resin being such that when the fabric is wetted with the composition, an amount of the resin is present on the fabric to impart stain and water repellency to the fabric when the fabric is dried and the resin is cured, said concentration being in the range of from about 3% to about 4% resin solids in the composition.

2. An aerosol product as claimed in claim 1, wherein:
a mass of gas storage material is in the container, storing under pressure a quantity of gaseous propellant for release into the container to maintain a desired pressure in the container.

3. A process for consumer application of a treatment to previously untreated fabric to impart stain and water repellency to the fabric, comprising the steps of:
preparing a composition containing a resin having the property of imparting stain and water repellency to fabric when applied to the fabric and cured, and a diluent that dilutes the concentration of resin in the composition to 3% to 4% resin solids that will result in an amount of the resin being present on the fabric to impart stain and water repellency to the fabric when the composition is sprayed onto a dry fabric in a quantity sufficient to wet the fabric;
spraying the composition onto dry fabric in a quantity to wet the fabric with the composition; and
drying the fabric and curing the resin to impart stain and water repellency to the fabric.

4. A process as claimed in claim 3, wherein:
the composition is applied to the fabric by spraying it from an aerosol container.

5. A process as claimed in claim 3, wherein:
the resin is cured by heating the wetted fabric.

6. A process as claimed in claim 5, wherein:
heating is accomplished by ironing the fabric.

7. A process as claimed in claim 5, wherein:
heating is accomplished by drying the wetted fabric in a clothes dryer.

8. A process as claimed in claim 3, wherein:
the resin is cured by heating the wetted fabric.

9. A process as claimed in claim 8, wherein:
heating is accomplished by ironing the fabric.

10. A process as claimed in claim 8, wherein:
heating is accomplished by drying the wetted fabric in a clothes dryer.

11. A process as claimed in claim 3, wherein:
the resin comprises an aqueous based fluoropolymer resin.

12. A process as claimed in claim 11, wherein:
the resin is present in the composition at a concentration of 3% to 4% resin solids.

13. A process as claimed in claim 12, wherein:
the diluent comprises water.

14. A process as claimed in claim 13, wherein:
a corrosion inhibitor and a propellant are placed in the container along with the composition.

15. A process as claimed in claim 3, wherein:
a gaseous propellant is used in the container to pressurize and discharge the composition; and
a mass of gas adsorbent material is in the container for storing under pressure a quantity of the gaseous propellant for release into the container as product is depleted.
